(19) United States
(12) Patent Application Publication
(10) Pub. No.: US 2003/0182862 A1
(43) Pub. Date: Oct. 2, 2003

(54) Method for obtaining hydrogen from hydrocarbons

(76) Inventor: Walter Jager, Engelskirchen (DE)

Correspondence Address: LERNER AND GREENBERG, P.A., POST OFFICE BOX 2480, HOLLYWOOD, FL, 33022-2480, US

(21) Appl. No.: 10/417,485

(22) Filed: Apr. 17, 2003

Related U.S. Application Data
(63) Continuation of application No. PCT/EP01/12065, filed on Oct. 18, 2001.

(30) Foreign Application Priority Data
Oct. 18, 2000 (DE) 100 51 563.0

(51) Int. Cl. C01B 3/24

(52) U.S. Cl. 48/197 R; 48/198.1; 48/198.3; 48/198.7; 48/211; 48/212; 48/214 R; 48/215; 48/214 A

(57) ABSTRACT

A method for generating a hydrogen-containing product gas from liquid or gaseous hydrocarbons includes providing a reformer installation having a combustion space, a mixing chamber and a reformer unit. Partial oxidation of a first hydrocarbon stream with a first oxygen-containing gas stream is performed and a first product-gas stream containing hydrogen is formed, in the combustion space. A second hydrocarbon stream is reformed with water and a second product gas stream containing hydrogen is formed, in the reformer unit. The first product-gas stream and the second product-gas stream are mixed in the mixing chamber to form a third product-gas stream. The reformer unit is heated with the third product-gas stream.

### CROSS-REFERENCE TO RELATED APPLICATION

This application is a continuation of copending International Application No. PCT/EP01/12065, filed Oct. 18, 2001, which designated the United States and was not published in English.

### BACKGROUND OF THE INVENTION

### FIELD OF THE INVENTION

The invention relates to a method for generating a hydrogen-containing product gas from liquid or gaseous hydrocarbons. The hydrogen which is obtained is used, for example, to operate a fuel cell facility.

It is known to use steam reforming to reform a hydrocarbon or hydrocarbon derivative such as, for example, methanol. However, the steam reforming reactions are substantially endothermic and take place at a reaction temperature which is higher than room temperature. Therefore, during a cold start of the reformer installation, the steam reforming cannot provide hydrogen immediately, rather the reformer installation first has to be heated to a suitable operating temperature. It is desirable for it to be possible to produce the required quantity of hydrogen as far as possible without delay, particularly in the case of reformer installations which are operated discontinuously or with differing load conditions. It is necessary for sufficient hydrogen as a function of the instantaneous driving power to be provided as quickly as possible, particularly when a reformer installation of that type is used with a fuel cell facility in a motor vehicle.

Fuel cells represent an important application area for such hydrogen generation technology, allowing the chemical energy of fossil fuels to be converted directly into electrical energy. However, modern fuel cells used for that purpose, for example PEM cells, if they are to operate without problems, only tolerate very small amounts of the carbon monoxide formed as a byproduct during the hydrocarbon conversion reactions. When a known low-temperature fuel cell is operating, for example, there is only approximately 50 ppm (parts per million) of the carbon monoxide in the product gas.

Various measures have already been proposed with a view toward improving the cold-starting properties of the reforming installation and the generation of high-purity hydrogen.

For example, it is already known from French Patents 1,417,757 and 1,417,758 to initially introduce a mixture of methanol and an oxidizing agent into the reforming reactor during a cold start of an installation for steam reforming of methanol, in order to carry out a corresponding combustion reaction there and as a result to heat up the reactor. Then, the supply of the oxidizing agent is ended and instead the methanol/steam mixture which is to be reformed is supplied and the steam reforming reaction is commenced.

It is known from German Published, Non-Prosecuted Patent Application DE 44 23 587 A1 to generate hydrogen optionally through the use of exothermic partial oxidation and/or endothermic steam reforming of methanol, in a reforming reactor which is filled with suitable catalyst material, e.g. Cu/ZnO material, depending on the control of the supply of the individual reaction partners to the reactor and the temperature prevailing therein. If the process is carried out in a suitable way, the two reactions proceed in parallel, with it being possible to establish an autothermal reaction sequence.

Further installations for the steam reforming of a hydrocarbon are described, for example, in U.S. Pat. Nos. 4,820,594 and 5,110,559. In the steam reforming installations described in those documents, a burner is integrated in the reforming reactor and is in thermal contact with the reaction space of the reactor through a heat-conducting partition. During a cold start, a combustible mixture is burnt in the burner with an open flame. In U.S. Pat. No. 5,110,559 that mixture originates from the reforming reactor itself and the combustible hydrocarbon which is to be reformed is fed to the reaction space even during the cold start. The hot combustion exhaust gases from the burner integrated in the reactor are passed on into a downstream CO shift converter in order to heat the latter and to thereby bring the installation to its operating temperature more quickly.

### SUMMARY OF THE INVENTION

It is accordingly an object of the invention to provide a method for obtaining hydrogen from hydrocarbons, that is a method for generating a hydrogen-containing product gas from liquid or gaseous hydrocarbons, which overcomes the hereinafore-mentioned disadvantages of the heretofore-known methods of this general type and in which a reformer installation has an improved cold-start and load-change performance, so that a required quantity of hydrogen can be provided very quickly.

With the foregoing and other objects in view there is provided, in accordance with the invention, a method for generating a hydrogen-containing product gas from liquid or gaseous hydrocarbons, which comprises providing a reformer installation having a combustion space, a mixing chamber and a reformer unit. Partial oxidation of a first hydrocarbon stream is performed with a first oxygen-containing gas stream and a first product-gas stream containing hydrogen is formed, in the combustion space. A second hydrocarbon stream is reformed with water and a second product gas stream containing hydrogen is formed, in the reformer unit. The first product-gas stream and the second product-gas stream are mixed in the mixing chamber to form a third product-gas stream. The reformer unit is heated with the third product-gas stream.

In this context, liquid or gaseous hydrocarbons are to be understood as meaning both relatively short-chain hydrocarbons and their derivatives (e.g. methane, methanol) and more complex hydrocarbon compounds (such as those which are found in gasoline, for example). Furthermore, it should be noted that in structural terms there is no need for there to be a strict delineation between the combustion space and the mixing chamber in the reformer installation. Rather, the combustion space may also form a region in the interior of the reformer installation in which the partial oxidation preferably takes place, while in another partial region of the reformer installation the process of mixing the two product-gas streams is dominant. The basic operations which take place during the partial oxidation and the reforming, in particular the steam reforming, are to be explained below.

The partial oxidation generates carbon monoxide (CO) as a byproduct which has to be removed from the product-gas stream for fuel cells to operate. The primary reaction equation in the partial oxidation is as follows: CₘHₙ+m/2O₂→mCO+n/2H₂. In this equation, CₘHₙ represents a hydrocarbon compound where m is the number of carbon atoms and n is the number of hydrogen atoms. The quantitative determination of the starting gas streams is effected in a known manner in accordance with the given reaction. If too much oxygen is added, complete oxidation occurs. In this case, the products would be carbon dioxide (CO₂) and water (H₂O), and consequently the efficiency in terms of hydrogen generation would be reduced. If too little oxygen is added, the process would slowly change to pyrolysis, with soot being produced as a byproduct and then being deposited in the reformer installation, from where it can only be removed with very considerable outlay. Starting the partial oxidation requires an activation energy, and the process then proceeds substantially exothermically (with heat being released). These reactions substantially take place in a temperature range from 800 to 1,300° C.

The steam reforming likewise generates carbon monoxide (CO) as a byproduct but also converts the steam into hydrogen (H₂). Depending on the hydrocarbons (CₘHₙ) used, the reaction equation is in this case: CₘHₙ+mH₂O→mCO+(n/2+m)H₂However, the steam reforming takes place endothermically, i.e. requires energy. The highest yield of H₂ in this case can be achieved at temperatures of 600-800° C., while the use of catalysts containing copper, zinc, nickel, rhodium, cobalt and precious metals (e.g. platinum) allows a shift toward lower temperatures.

The method according to the invention generates two product-gas streams in the reformer installation, the first product-gas stream being at a significantly higher temperature than the second product-gas stream, due to the partial oxidation. The mixing of the two product-gas streams leads to the formation of a third product-gas stream, the volume of which is sufficiently large to allow an intensive heat transfer from the third product-gas stream to the reformer unit. In this way, the reformer unit, in which predominantly the endothermic steam reforming takes place, is rapidly heated after a cold start and in the event of highly dynamic load changes, with the result that the yield of hydrogen is rapidly matched to the level required for the subsequent generation of energy.

In accordance with another mode of the invention, the first product-gas stream and the second product-gas stream are mixed in countercurrent. This means that the first product-gas stream of the partial oxidation flows into the mixing chamber in the opposite direction to the second product-gas stream of the reformer unit. This results in virtually complete mixing of the two product-gas streams, with the result that a third product-gas stream is formed, having a substantially uniform temperature distribution. This has the advantage that in this way uniform introduction of heat into the reformer unit by the third product-gas stream is also ensured.

In accordance with a further mode of the invention, the third product-gas stream comes into direct contact with the reformer unit. This means that the third product-gas stream may, for example, be guided past the outside of the reformer unit. However, in addition it is also possible to allow the third product-gas stream to flow through separate passages passing through inner regions of the reformer unit, preventing the third product-gas stream from mixing with the second hydrocarbon stream. This has the advantage that the contact surface area is increased and the inner regions of the reformer unit can also be heated in this manner.

In accordance with an added mode of the invention, the second hydrocarbon stream is mixed with a second oxygen-containing gas stream after the reforming. The second hydrocarbon stream is then oxidized, with further hydrogen being generated. In this way, a substantially three-stage reformer unit is formed, in which three chemical reaction processes take place in the direction of flow of the second hydrocarbon stream. First of all, immediately after the second hydrocarbon stream has been introduced into the reformer unit, a methanizing reaction takes place in which, by way of example, complex hydrocarbon compounds (CₘHₙ) are converted exothermically into methane (CH₄). Then, as the temperatures rise, the steam reforming takes place. This predominantly leads to endothermic cracking of the methane. What is known as a shift reaction also takes place as a subordinate reaction, in which the carbon monoxide generated by the steam reforming is converted into carbon dioxide with the aid of excess water. The reaction equation for the shift reaction is as follows: CO+H₂O [symbol] CO₂+H₂. Then, oxygen is admixed and the methane which is still present in the hydrocarbon stream is oxidized. Although hydrogens are also consumed in this oxidation, in this way a methane-free second product-gas stream is produced. This is highly important in particular with a view toward further use of the product-gas stream for operation of a fuel cell.

In accordance with an additional mode of the invention, the first hydrocarbon stream and the second hydrocarbon stream are regulated as a function of the temperature in the reformer installation. This means, for example, that in the cold-starting phase of the reformer installation (i.e. at low temperatures), a larger quantity of the first hydrocarbon stream is supplied. The result of this is that the exothermic partial oxidation takes place to an increased extent. As a result, sufficient thermal energy to heat the reformer unit can be made available very quickly.

In accordance with again another mode of the invention, the carbon monoxide content of the third product-gas stream is reduced in a purification installation. The purification installation is connected downstream of the reformer installation and ensures the required purity of the hydrogen-containing product gas for further use in a fuel cell facility. The residual level of carbon monoxide which is still present in the product gas can be reduced in this way to concentrations of less than 1,000 ppm or even 10 ppm. The hydrogen-containing product gas produced is therefore also suitable for low-temperature fuel cells.

In accordance with again another mode of the invention, the invention proposes a method for generating a hydrogen-containing product gas from liquid or gaseous hydrocarbons, in which a reformed and purified product-gas stream with a high hydrogen content is fed to a fuel cell facility, where it is reacted in order to generate energy. The exhaust gas discharged from the fuel cell facility is used to heat the reformer unit. Therefore, a heat flux can additionally be made available to the reformer unit, assisting the operation of heating the reformer unit.

In accordance with a concomitant mode of the invention, in this context, it is particularly advantageous for the exhaust gas to then be fed back to the second hydrocarbon stream. Tests have shown that under certain circumstances the exhaust gas may still have a residual hydrogen content (up to approximately 10%). In this way, this hydrogen content can be fed back to the reformer unit, so that the hydrogen content of the product gas which is generated is increased.

Other features which are considered as characteristic for the invention are set forth in the appended claims.

Although the invention is illustrated and described herein as embodied in a method for obtaining hydrogen from hydrocarbons, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a diagrammatic, schematic and block circuit diagram of a reformer installation for carrying out the method according to the invention, with a downstream purifying installation and a fuel cell facility.

### DESCRIPTION OF THE PREFERRED EMBODIMENTS

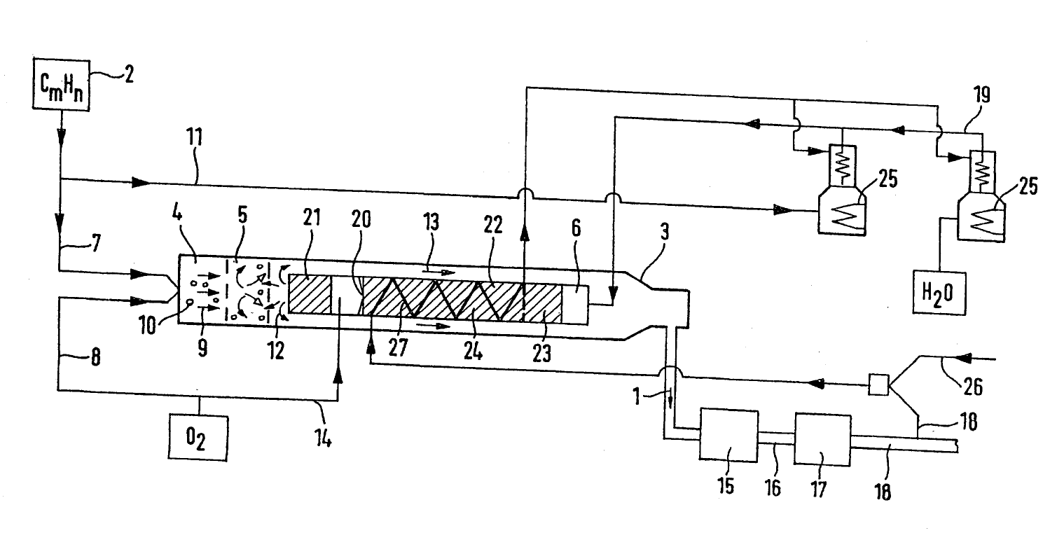

Referring now to the figures of the drawings in detail and first, particularly, to FIG. 1 thereof, there is seen a reformer installation 3 which is suitable for carrying out the method according to the invention for generating a hydrogen-containing product gas 1 from liquid or gaseous hydrocarbons 2. The reformer installation has a combustion space 4, a mixing chamber 5 and a reformer unit 6. The reformer unit 6 is encapsulated with respect to the interior of the reformer installation 3 and has only one outlet 20 through which a second product-gas stream 12 can flow into the mixing chamber 5.

A first hydrocarbon stream 7 and a first oxygen-containing gas stream 8 are introduced into the combustion space 4. The oxygen contained in the gas stream 8 is used as an oxidizing agent for the hydrocarbons 2 contained in the first hydrocarbon stream 7. The selection of the type of hydrocarbons 2 is not subject to any particular limitation, which means that even complex hydrocarbons 2 such as, for example, those which are found in gasoline, can be introduced into the reformer installation 3. A strongly exothermic reaction, which produces excess heat, occurs in the combustion space 4, after a one-time or single activation (e.g. through the use of a spark). Temperatures of approximately 900 to 1,000° C. occur in the combustion space 4. The pressure is approximately 1.427 bar. The oxygen-containing gas being used is air. The above-described division of the hydrocarbon with a relatively small first hydrocarbon stream 7 is particularly advantageous in this context, since correspondingly smaller amounts of air and therefore nitrogen then have to be introduced. The lower nitrogen content in the combustion space 4 allows more rapid heating of the reformer installation 3. Under these conditions, a first product-gas stream 9 which has a hydrogen content of approximately 27% is generated. In addition to hydrogen, the first product-gas stream 9 contains, in particular, approximately 25% carbon monoxide and 47% nitrogen. However, the hydrogen content of the first product-gas stream 9 which forms may be up to approximately 50%, with the carbon monoxide content being approximately 3 to 4%.

A second hydrocarbon stream 11 is reformed in the reformer unit 6 by using water 19, so as to form the second product-gas stream 12 which contains hydrogen 10. The reforming of the second hydrocarbon stream 11 takes place substantially through the use of what is known as steam reforming. In this case, the water 19 on one hand, due to its oxygen content, acts as an oxidizing agent in order to separate the hydrogen contained in the second hydrocarbon stream 11 from the carbon, and on the other hand also itself contributes to hydrogen production. Therefore, pure steam reforming processes give the highest hydrogen yields of all reforming processes, even at a relatively low temperature level. Different catalysts can be used according to the hydrocarbon being used. All of these catalysts have to be activated by reduction with hydrogen or carbon monoxide and, as the process continues, have to be kept free of oxygen. Steam reforming reactions are strongly endothermic and therefore require external heat sources. The hydrogen content of the second product-gas stream 12 is therefore above that of the first product-gas stream 9, while the carbon monoxide content is lower.

The second hydrocarbon stream 11 is firstly passed through a first evaporator 25, in which liquid constituents of the gasoline are converted to a gaseous state. The evaporated gasoline is mixed with the water 19 which has likewise been evaporated. This mixture is then introduced into the reformer unit 6. The reformer unit 6 is constructed in this case with a primary reformer 22 and a secondary reformer 21.

First of all, a methanizing reaction takes place in a first partial region 23 of the primary reformer 22. This substantially involves a slightly exothermic conversion of complex hydrocarbons contained in the gasoline into methane. In order to enable this methanizing reaction to take place even at temperatures of approximately 400° C., catalysts which include, for example, constituents of nickel, rhodium, cobalt or platinum are used in this partial region 23.

Following this methanizing reaction in the first partial region 23, the steam reforming takes place primarily in a second partial region 24. In addition, an exothermic shift reaction with water takes place (to a small extent) for conversion of the carbon monoxide. The steam reforming is preferably operated with excess water.

A second oxygen-containing gas stream 14, in particular air, is supplied after the steam reforming. This is followed by additional oxidation in the secondary reformer 21 at a pressure of approximately 1.44 bar and a temperature of 740° C. In the process, residual quantities of methane are removed from the second product-gas stream 12. The second product-gas stream 12 then has a hydrogen content of approximately 47%, a carbon monoxide content of approximately 9% and a water content of approximately 35%.

The division of the first hydrocarbon stream 7 to form the second hydrocarbon stream 11 preferably takes place in a ratio of approximately 2:3. If the hydrocarbons 2 are, for example, gasoline, in which case approximately 10 kg of gasoline/h are required for a certain performance on the part of a fuel cell facility 17, the first hydrocarbon stream 7 is accordingly approximately 4 kg/h and the second hydrocarbon stream 11 is approximately 6 kg/h.

The first product-gas stream 9 and the second product-gas stream 12 are mixed in the mixing chamber 5. The combustion space and the mixing chamber are not structurally separated from one another in this case. Unlike a situation in which the combustion space 4 and the mixing chamber 5 are spaced apart from one another, the illustrated embodiment prevents, for example, a heat transfer from the hot first product-gas stream 9 to additional walls of the combustion chamber 4 or of the mixing chamber 5. The distinction which has been drawn between a combustion space 4 and a mixing chamber 5 was made in particular to provide a more detailed explanation of the chemical and physical operations which take place in the regions of the reformer installation. In the mixing chamber 5, the first product-gas stream 9 and the second product-gas stream 12 form a third product-gas stream 13, which product-gas stream is used to heat the reformer unit 6.

The third product-gas stream 13 which is formed in this way has a uniform temperature distribution and flows past the outside of the reformer unit 6. In the process, the third product-gas stream 13 comes into contact with the reformer unit and in this manner ensures the availability of the quantity of heat required for the endothermic steam reforming. This heat transfer process keeps the starting and load-change times of the reformer as short as possible. In addition, the thermal efficiency of the steam reforming can be increased as a result of further heat which is produced in the overall process such as, for example, heat of an exhaust gas 18 from the fuel cell 17, being used for the steam reforming.

It is desirable, even during the reforming, to produce a product-gas stream 12 which as far as possible has no residual content of, for example, methane, with a view toward subsequent purification of the third product gas 13. Due to the temperatures which occur in the reformer unit 6 close to the introduction of the second hydrocarbon stream 11 (approximately 400° C.), first of all methanizing of the second hydrocarbon stream 11 commences. This means that a large number of the complex hydrocarbons 2 (CₘHₙ) are converted into methane (CH₄). This methanizing process is followed, in the direction toward the outlet 20, by the steam reforming. In the illustrated circuit diagram, after the reforming, the second hydrocarbon stream 11 is mixed with the second oxygen-containing gas stream 14. In the direction of the outlet 20 there then follows an oxidation of the second hydrocarbon stream 11, in which further hydrogen 10 is generated. In this way, any residual quantity of methane which still remains in the hydrocarbon stream 11 is reacted.

The third product-gas stream 13 produced in this way has a carbon monoxide content which is so high that it causes considerable problems for use for fuel cells. For this reason, the carbon monoxide content of the third product gas stream 13 is reduced in a subsequent purification installation 15. The carbon monoxide is reacted in a purification installation 15. In this way, the carbon monoxide concentrations in a purified product gas 16 are reduced to less than 1,000 ppm, in particular less than 100 ppm.

The reformer unit 6 has a heating device 27 in order to further improve the cold-starting performance of the reformer unit 6. By way of example, the hot exhaust gas 18 from the fuel cell facility 17 and/or a hydrocarbon-containing heating gas 26 flows through the heating device 27. A heating device 27 of this type shortens the starting time which the reformer unit 6 requires to reach the temperatures which are necessary for the steam reforming. The exhaust gas 18 or the heating gas 26 is then fed to the evaporators 25, ultimately being admixed with the mixture of the second hydrocarbon stream 11 and the water 19. In this way, the hydrogens or hydrocarbons which are still present in the exhaust gas 18 or heating gas 26 can be used for the steam reforming in the primary reformer 22.

Therefore, it is accordingly possible to implement a process sequence for generating hydrogen from gaseous or liquid hydrocarbons through the use of steam reforming and partial oxidation which is suitable for use in modern fuel cells. Product-gas streams for heating the reformer unit enable the reformer installation to be operated even with highly dynamic load changes.

I claim:

1. A method for generating a hydrogen-containing product gas from liquid or gaseous hydrocarbons, which comprises:
a) providing a reformer installation having a combustion space, a mixing chamber and a reformer unit;
b) performing partial oxidation of a first hydrocarbon stream with a first oxygen-containing gas stream and forming a first product-gas stream containing hydrogen, in the combustion space;
c) reforming a second hydrocarbon stream with water and forming a second product gas stream containing hydrogen, in the reformer unit;
d) mixing the first product-gas stream and the second product-gas stream in the mixing chamber to form a third product-gas stream; and
e) heating the reformer unit with the third product-gas stream.

2. The method according to claim 1, which further comprises carrying out the step of mixing the first product-gas stream and the second product-gas stream in countercurrent.

3. The method according to claim 1, which further comprises carrying out the step of heating the reformer unit with the third product-gas stream by bringing the third product-gas stream into contact with the reformer unit.

4. The method according to claim 1, which further comprises, after the reforming step, mixing the second hydrocarbon stream with a second oxygen-containing gas stream, and then oxidizing the second hydrocarbon stream generating further hydrogen.

5. The method according to claim 1, which further comprises regulating the first hydrocarbon stream and the second hydrocarbon stream as a function of a temperature in the reformer installation.

6. The method according to claim 1, which further comprises reducing a carbon monoxide content of the third product-gas stream in a purification installation.

7. The method according to claim 6, which further comprises feeding the reformed and purified product-gas stream with a high hydrogen content to a fuel cell facility, reacting the reformed and purified product-gas stream in the fuel cell facility to generate energy, and heating the reformer unit with exhaust gas discharged from the fuel cell facility.

8. The method according to claim 7, which further comprises then feeding the exhaust gas to the second hydrocarbon stream.
